(19) United States
(12) Patent Application Publication
(10) Pub. No.: US 2007/0100789 A1
(43) Pub. Date: May 3, 2007

(54) Bulk keyword import/export system and method

(76) Inventors: Dipendra Malhotra, Princeton, NJ (US); John Vandermay, Draper, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 11/510,067

(22) Filed: Aug. 24, 2006

Related U.S. Application Data
(60) Provisional application No. 60/731,175, filed on Oct. 28, 2005.

(51) Int. Cl. G06F 17/30

(52) U.S. Cl. 707/1

(57) ABSTRACT

A system and method allows a user to automatically upload or download Internet advertising keywords to/from a search engine. A plug-in module may be used with a spreadsheet application used to maintain a collection of keywords. The plug-in module facilitates the bulk transfer of keywords between the spreadsheet application and a bid management system, which is used to purchase and price keywords from the search engine.

### CROSS-REFERENCE TO RELATED APPLICATIONS

The present application claims priority, under 35 U.S.C. § 119(e), of U.S. Provisional Patent Application No. 60/731,175, filed Oct. 28, 2005 and entitled “Bulk Keyword Import/Export System and Method”, the entirety of which is hereby incorporated by reference.

### BACKGROUND

The rapid growth in accessibility and use of the Internet has drawn an increasing number of businesses into using the Internet as a vehicle to attract potential customers. In many cases, businesses are relying on the Internet as their sole or primary marketing and advertising conduit. It is now commonplace for online and “brick-and-mortar” businesses to work with search engines in an effort to direct search engine users to their businesses. Such relationships generally revolve around the use of keywords (or key phrases), the rights to which are purchased from search engines by businesses, in response to which the search engines conspicuously display advertising associated with the businesses when a user inputs the particular purchased keywords. For example, a shoe company may purchase the keyword “sandal” from a search engine, so that when a user inputs “sandal” in the search engine, the search engine prominently displays a link to the shoe company or advertising associated therewith.

The pricing of keywords can vary depending on any one or more of a number of factors including, but not limited to, the demand for a particular keyword (the more sought a keyword is, the higher its value), the number of searches including particular keywords, time of usage for keywords, and ad position. Further, the cost of a particular keyword may be fixed, or the cost may depend on the number of users that click on an advertising link returned in response to a search of the keyword. The amount of money a business spends on online advertising is referred to in the art as “ad-spend”, and the general goal of businesses advertising on the Internet is to minimize ad-spend and maximize not necessarily traffic through their website, but ultimate revenue generated from that traffic.

It is not uncommon for businesses keen on, online advertising to purchase hundreds or thousands of keywords from one or more search engines. Typically, the management of such large numbers of keywords is performed manually with human users actually inputting the keywords. For example, keywords are currently managed using any one of a number of spreadsheet (e.g., Excel® by Microsoft Corporation) or document formats (e.g., Word® by Microsoft Corporation). Users generally list the keywords in a spreadsheet or document and then convert the document such that the keywords are listed in a format that is convertible and uploadable to a search engine. As indicated above, large advertising campaigns can have tens of thousands of keywords as part of an Internet marketing strategy. Therefore, those skilled in the art will note that such manual management of keywords can be cumbersome and prone to error.

### SUMMARY

According to at least one aspect of one or more embodiments of the present invention, a computer-implemented method of handling keywords for Internet advertising includes: operatively interfacing a spreadsheet application with a search engine, where the spreadsheet application is arranged to operate on a file having a collection of keywords; and enabling a user to automatically at least one of upload at least a portion of the collection of keywords to the search engine and download at least a portion of the collection of keywords from the search engine.

According to at least one other aspect of one or more embodiments of the present invention, a system for handling keywords for Internet advertising includes: a spreadsheet application arranged to operate on a file having a collection of keywords; a bid management system operatively connected to a search engine and arranged to purchase keywords based on the collection of keywords; and a plug-in module arranged to at least one of automatically export at least a portion of the collection of keywords from the spreadsheet application to the bid management system and import at least a portion of the collection of keywords to the spreadsheet application from the bid management system.

According to at least one other aspect of one or more embodiments of the present invention, a computer-readable medium having instructions stored therein and that are executable by a processor to: operatively interface a spreadsheet application with a search engine, where the spreadsheet application is arranged to operate on a file having a collection of keywords for Internet advertising; and enable a user to automatically at least one of upload at least a portion of the collection of keywords to the search engine and download at least a portion of the collection of keywords from the search engine.

The features and advantages described herein are not all inclusive, and, in particular, many additional features and advantages will be apparent to those skilled in the art in view of the following description. Moreover, it should be noted that the language used herein has been principally selected for readability and instructional purposes and may not have been selected to circumscribe the present invention.

### BRIEF DESCRIPTION OF DRAWINGS

FIG. 1 shows a system in accordance with an embodiment of the present invention.

FIG. 2 shows an initial screen of a spreadsheet application prior to use of an embodiment of the present invention.

FIG. 3 shows a login screen in accordance with an embodiment of the present invention.

FIG. 4 shows a screen of a spreadsheet application after login in accordance with an embodiment of the present invention.

FIG. 5 shows a “fetch keywords” user interface in accordance with an embodiment of the present invention.

FIG. 6 shows a “loading keywords” wait window in accordance with an embodiment of the present invention.

FIG. 7 shows a screen of a spreadsheet application after keywords have been loaded in accordance with an embodiment of the present invention.

FIG. 8 shows a screen of a spreadsheet application with keyword changes in accordance with an embodiment of the present invention.

FIG. 9 shows an “upload keywords” user interface in accordance with an embodiment of the present invention.

FIG. 10 shows an “insert data block” user interface in accordance with an embodiment of the present invention.

FIG. 11 shows a “commit keywords” user interface in accordance with an embodiment of the present invention.

FIG. 12 shows a flow process in accordance with an embodiment of the present invention.

Each of the figures referenced above depict an embodiment of the present invention for purposes of illustration only. Those skilled in the art will readily recognize from the following description that one or more other embodiments of the structures, methods, and systems illustrated herein may be used without departing from the principles of the present invention.

### DETAILED DESCRIPTION

In the following description of embodiments of the present invention, numerous specific details are set forth in order to provide a more thorough understanding of the present invention. However, it will be apparent to one skilled in the art that the present invention may be practiced without one or more of these specific details. In other instances, well-known features have not been described in detail to avoid unnecessarily complicating the description.

Embodiments of the present invention generally relate to a system and/or method of automatically uploading and downloading keywords to and from one or more search engines (e.g., search engines provided by Google, Inc., Microsoft Corporation, and Yahoo! Inc). In one or more embodiments, a plug-in module may be added to a conventional spreadsheet (e.g., Excel® by Microsoft Corporation, Lotus 1-2-3® by IBM Corporation), where the plug-in module interfaces with a bid management system and/or web analytics tool to download keywords from a search engine and to upload keywords to the search engine. In such a manner, one or more embodiments provide an easy to use and seamless mechanism for the uploading and downloading of keywords to/from a search engine. Further, in one or more embodiments, a user, via a single input command (e.g., key press, mouse click) when operating within the spreadsheet, may upload or download keywords to/from a search engine.

In one or more embodiments, the plug-in module may interface with a bid management system such as, for example, SearchCenter by Omniture, Inc. Further, such a bid management system may interface with a web analytics tool such as, for example, SiteCatalyst by Omniture, Inc.

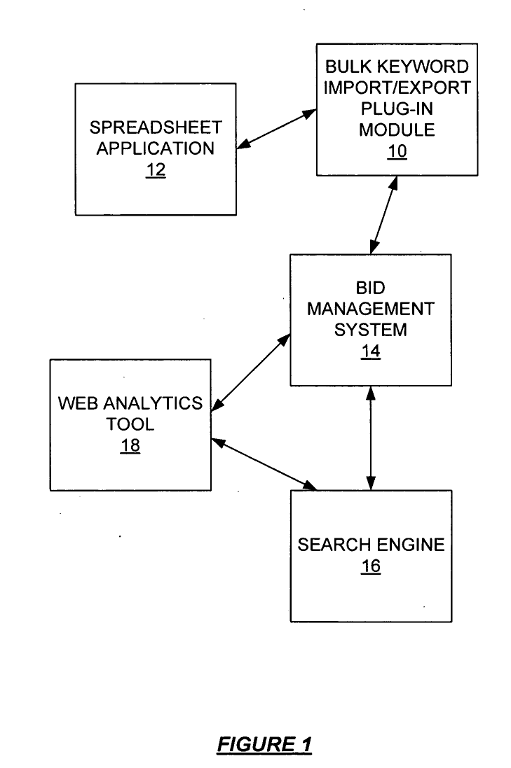

FIG. 1 shows a system in accordance with an embodiment of the present invention. A bulk keyword import/export module 10 serves as a plug-in to a spreadsheet application 12. However, those skilled in the art will note that in one or more other embodiments, the bulk keyword import/export module 10 may serve as a plug-in for a different document format (e.g., a word processing application).

The spreadsheet application 12 interfaces with a bid management system 14. Thus, the spreadsheet application 12 maintains a collection of keywords for the user, and the bid management system 14 relies on all or part of this collection when purchasing or pricing keywords. The bid management system 14 is operatively connected to a search engine 16 and communicates with the search engine 16 for, for example, the placement of keywords, transfer of advertising content, and collecting keyword and traffic statistics. Further, the bid management system 14 may interface with a web analytics tool 18, where the web analytics tool 18 measures performance and monitors use and traffic across a user's website.

In one or more embodiments, the bid management system 14 imports data from the spreadsheet application 12. In this manner, the bid management system 14 can import a large collection of keywords without requiring a user to manually enter them into the bid management system 14.

Keyword data management files may be controlled by a toolbar in the spreadsheet application 12. The keyword data may be organized in columns with one or more of the following heading attributes: Search Engine; Campaign name; Ad Group name; Keyword; Keyword Max CPC; Ad Group Max CPC; Keyword Status; Row Type; Ad Group Status; Ad Title; Ad Description; Ad Display URL; Ad Destination URL; and Ad Status.

Bulk Keyword Management

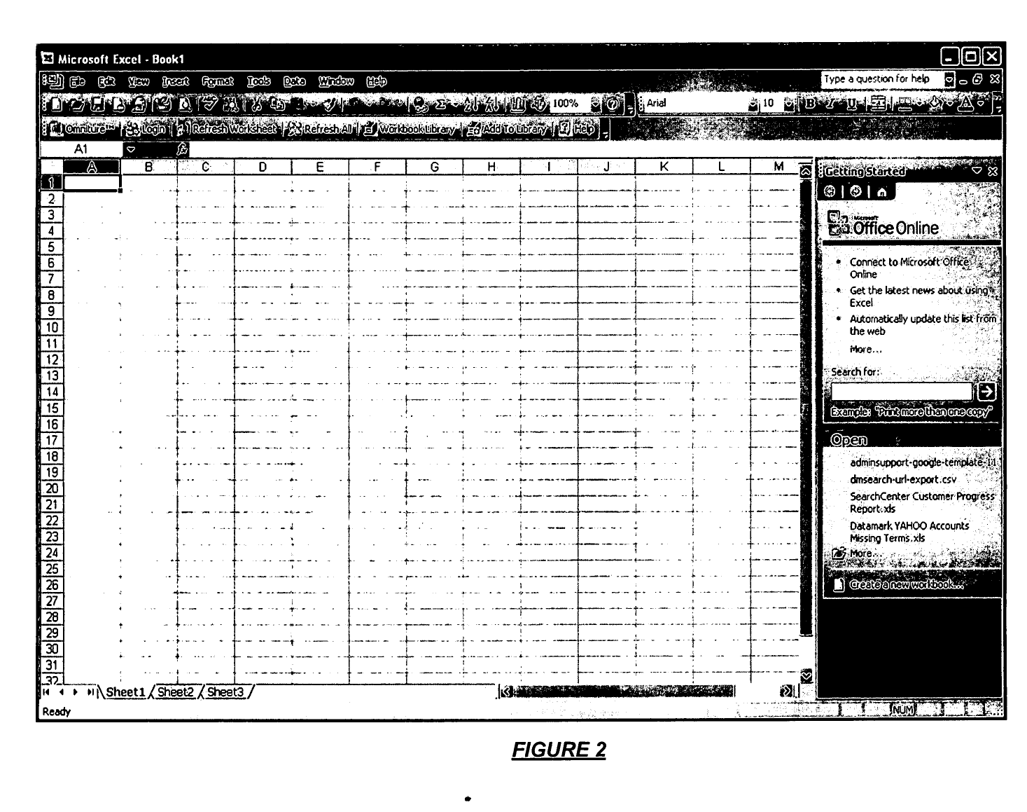

In one or more embodiments, a user begins keyword management by first opening up a spreadsheet application. FIG. 2 shows an example of an initial screen that is displayed to the user upon opening up the spreadsheet application. As shown in FIG. 2, there is an option entitled “Omniture” on the toolbar of the spreadsheet application. Here, the word “Omniture” is the name of the entity providing the bulk keyword management service, but those skilled in the art will note that this option may be entitled with any word or term.

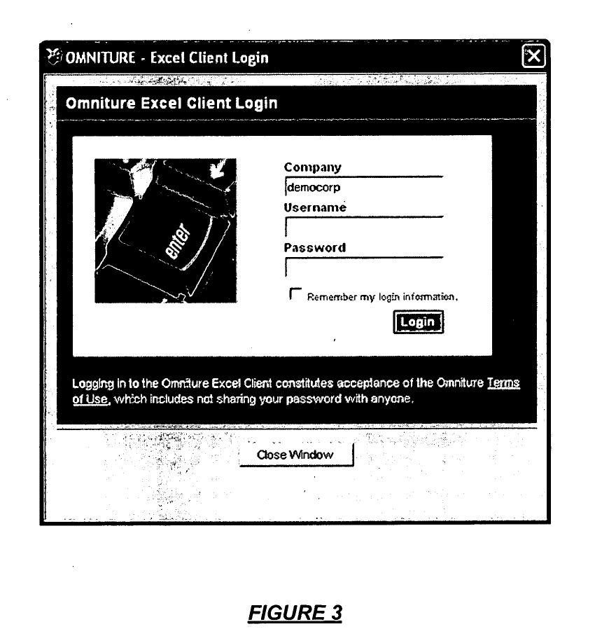

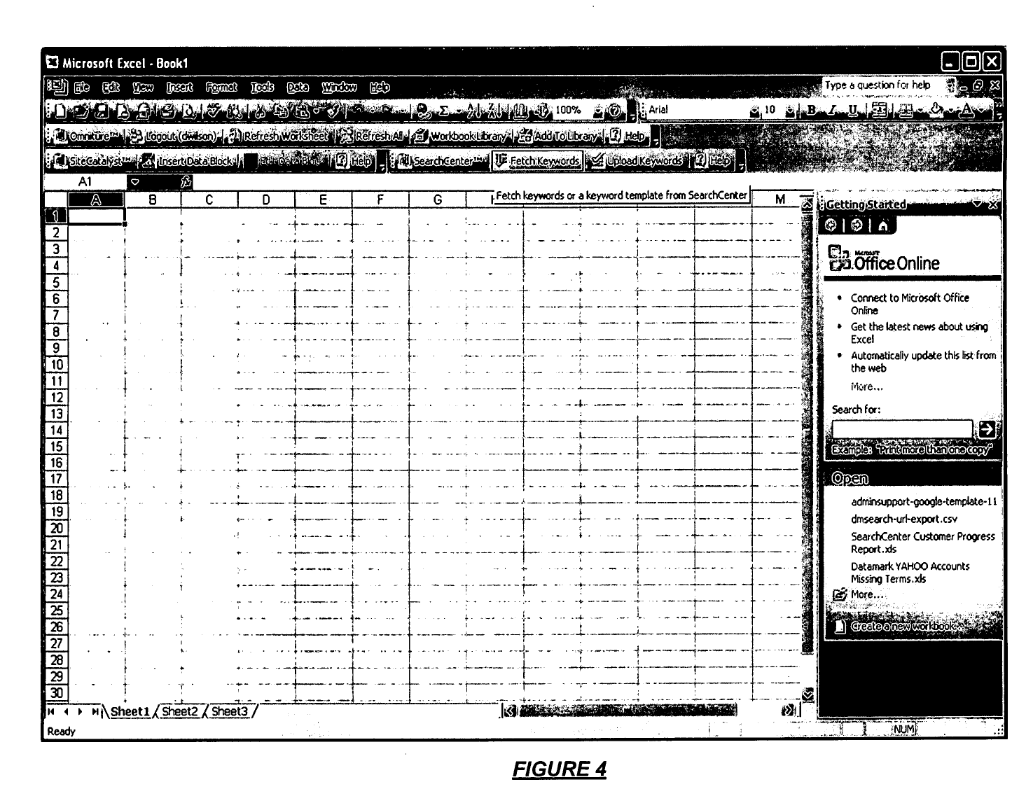

Once the bulk keyword management service option is selected from within the spreadsheet application shown in FIG. 2, a login window, such as the one shown in FIG. 3, is presented to the user in order to authenticate the user. After successfully log-in, a number of features are integrated with the spreadsheet application. In essence, this integration may be facilitated by a bulk keyword import/export plug-in module that is linked to the spreadsheet application upon successful log-in. The integration may be seen in FIG. 4, which shows a display of the spreadsheet application, having additional features (e.g., Insert Data Block, Edit Data Block, Fetch Keywords, Upload Keywords).

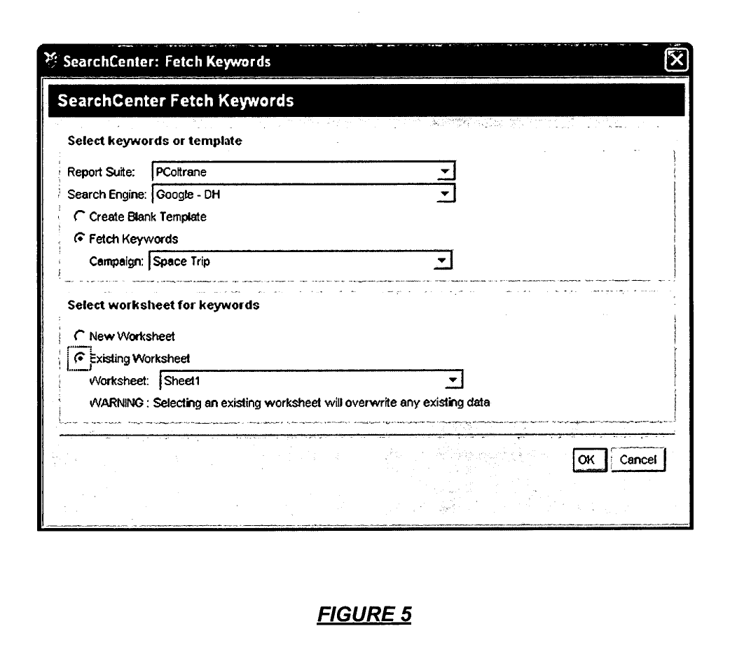

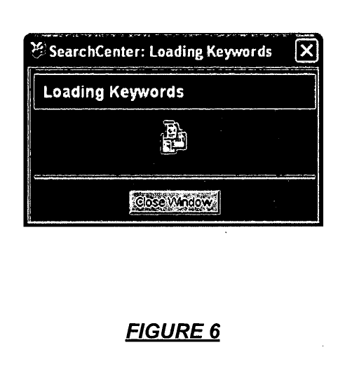

Actual bulk keyword management may begin by the user selecting to import keywords from a bid management system operatively interfaced with the spreadsheet application. FIG. 5 a user interface that a user may use to select parameters for importing keywords. The user may fetch keywords by selecting the report suite, search engine, and campaign. Further, the user can select whether to have the imported keywords populate a new worksheet or an existing worksheet. Upon clicking “ok”, the requested keywords are imported, during which a wait screen, such as the one shown in FIG. 6, may be displayed to the user.

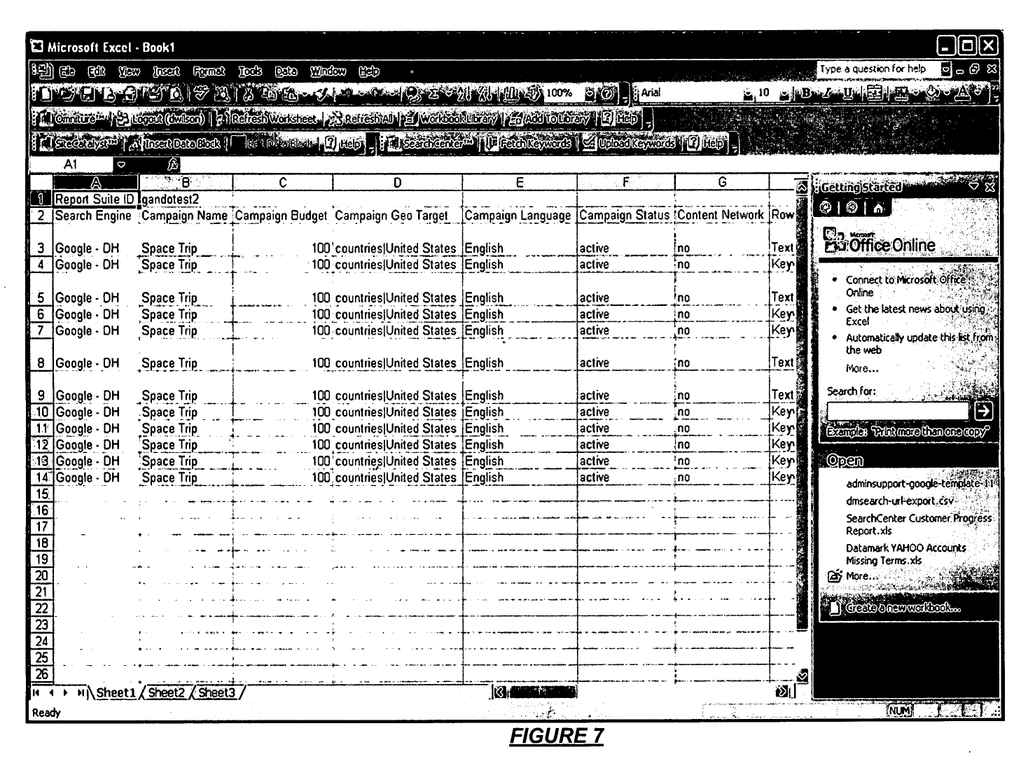

FIG. 7 shows a screen of the spreadsheet application after keywords have been imported according to the selections shown in FIG. 5. As can be seen in FIG. 7, the keywords are organized by columns entitled, for example, Search Engine, Campaign Name, Campaign Budget, Campaign Geographical (Geo) Target, Campaign Language, Campaign Status, and Content Network.

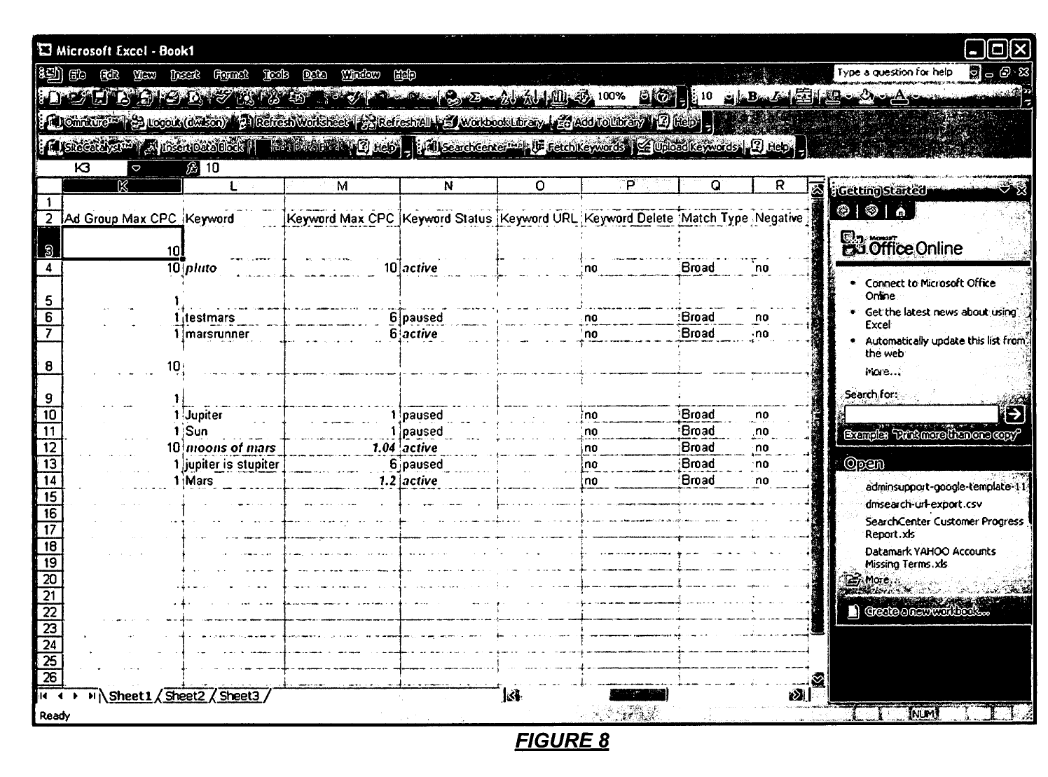

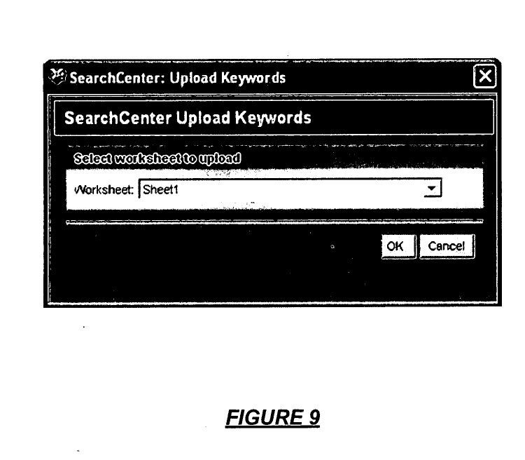

After keywords have been imported to the spreadsheet application, the user may make changes to the keywords and attendant attributes thereof, as shown in FIG. 8. The user may change, for example, an ad group max CPC, the keyword, the keyword max CPC, the keyword status, the keyword URL. Once the keywords and attendant attributes thereof have been changed according to a user's wishes, the user may save the changes and upload the keywords via an interface such as that shown in FIG. 9.

Within the bid management system 14, an option for “Manage Keywords” may be provided. If selected, a bulk keyword management screen may provide a link to download a toolbar (described above). The screen also displays information for importing data into the bid management system 14. File format details may be hidden and displayed when the user requests to see information for manual upload of files.

When a user account is created, or when the bid management system 14 is enabled in an account, a file transfer account may be created. When the user clicks on a bulk management menu item, the user may be presented with details of the file format, a link to download a template, and access information for the file transfer account. Once the template file is uploaded, the user may then upload an additional file with a predetermined extension so that the bid management system 14 is aware that the file is uploaded. Further, in one or more embodiments, any errors generated through the process may be sent to the user (or administrator) via e-mail.

It is important to note that in one or more embodiments, the user may have his/her collection of keywords and attendant data downloaded into their spreadsheet application on their local hard drive (or other data store). The data is retrieved by the plug-in using an application program interface (API) or web service in order to help make management efficient and easy.

Further, in one or more embodiments, the integration between the spreadsheet application 12 and the web analytics tool 18 may be enhanced and additional functionality may be added to the toolbar. Users may have the ability to insert a keyword block within any file, allowing them to have analysis data (from the web analytics tool 18) along with keyword management sections all within one file.

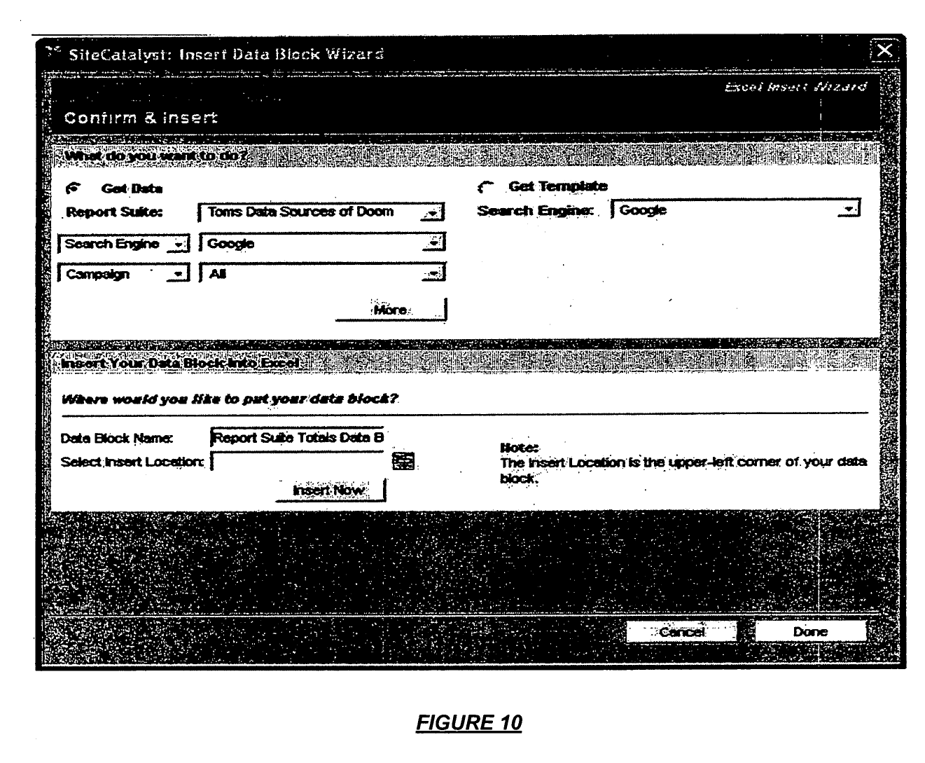

Additionally, selection of an “insert keywords” option may allow users to select whether they want to download a template or existing data (see FIG. 10). If template is selected, the user may select a specific search engine that allows the downloading of a template with search engine specific information. Otherwise, the user may select the desired reporting mechanism and other attributes. These attributes may be a search engine, a campaign, or multiple classifications. Further, the user may be required to select the location to insert into the spreadsheet. After confirmation, the data may then be populated into the top level of the spreadsheet.

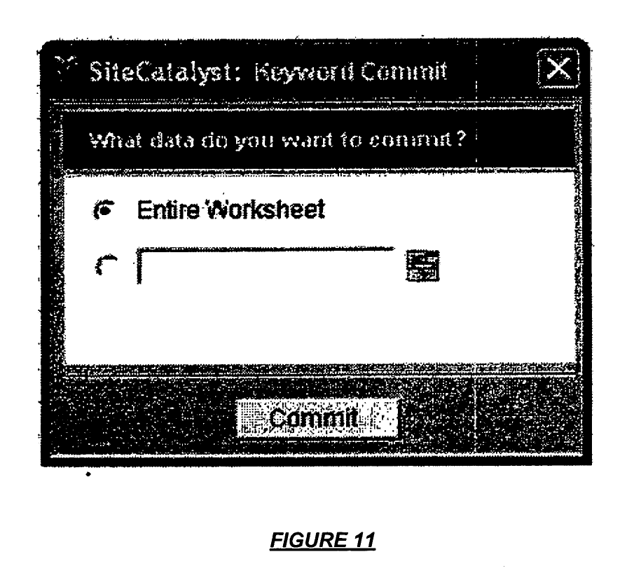

Further, in one or more embodiments, as shown in FIG. 11, an additional option may be added and labeled “commit keywords”. When within a keyword block, this option may present a confirmation window requesting the user to indicate whether they want to update the entire worksheet or select a block to update. It may default to the current block if possible. When outside of a keyword block, this option may be disabled. To reduce race conditions, the commit data functionality may create an upload file that only contains changes made by the user. Such functionality may be managed by an automatic “modified” column. In addition, as much error checking as possible may be handled in the plug-in to reduce delay error reports to the user.

An option may also be provided to allow a user to refresh data from the server. When a keyword block is within a file, a confirmation notice may be displayed indicating that changes since the last commit will be lost. This warning may be suppressed if no changes have been made since the last refresh or inserting of the data block.

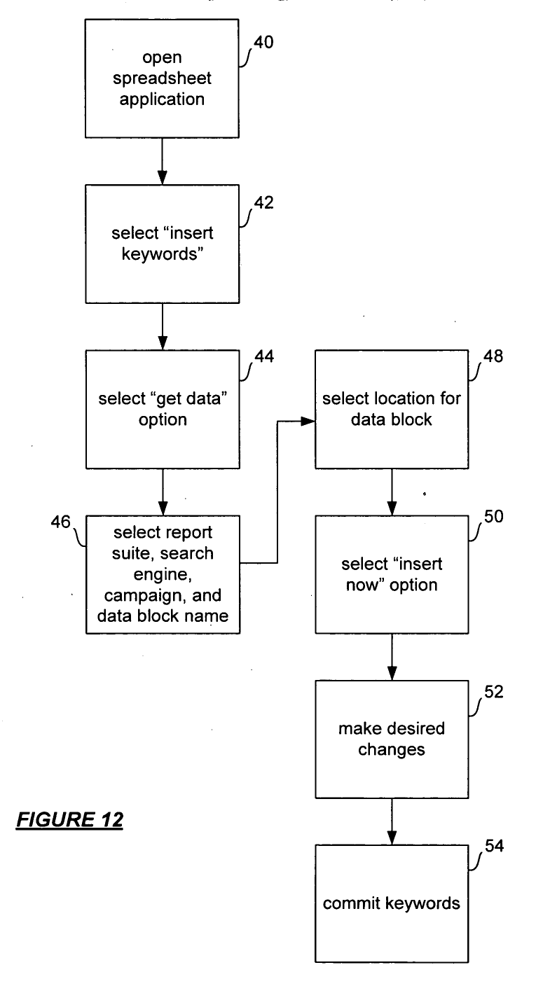

FIG. 12 shows a flow process of how a user may user the bulk keyword import/export plug-in module 10 to retrieve existing data and change a max CPC for a given ad group. Initially, the user, in step 40, opens the spreadsheet application 12. Once the spreadsheet application 12 is open, the user selects an “insert keywords” option in step 42. Thereafter, the user requests to retrieve data in step 44, whereupon the user, in step 46, selects a report suite, search engine, and campaign and gives that data block a name. The user further selects, in step 48, the location in which to insert the data block. Once these settings have been selected, the user, in step 50, may initiate the insertion of data, during which a message may be displayed to the user that the data is being retrieved.

Once that data has been imported, the user can then make any desired changes in step 52. Those skilled in the art will note that when there is a discrepancy between the retrieved data and the preexisting data, an indication of such may be made to the user.

When the user is ready to commit keywords (described above), the user, in step 54, may be prompted whether he/she wants to commit the entire worksheet or a specific block. The bulk keyword import/export module 10 will then update those rows modified by the user. After committing, the user may save and store the file and its contents until further editing is required.

Bulk Management Log

In one or more embodiments, each time data is changed, whether through a manual upload or through a spreadsheet application integration, a log entry may be kept that details the transaction and any errors. This may also provide an interface for the user to view the details of the errors and determine what needs to be changed to fix the problem. One or more of the following data may be kept in the log: upload data; username/account; status (complete, processing, errors); processed data/time; rows successfully processed (x of y); spreadsheet application upload (handled through plug-in or not); and details (link to show detailed errors).

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

In particular, one skilled in the art will recognize that other architectures and analysis and processing techniques and mechanisms may be used, and that the present invention can be implemented using mechanisms other than those described above.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A computer-implemented method of handling keywords for Internet advertising, comprising:
operatively interfacing a spreadsheet application with a search engine, wherein the spreadsheet application is arranged to operate on a file having a collection of keywords; and
enabling a user to automatically at least one of upload at least a portion of the collection of keywords to the search engine and download at least a portion of the collection of keywords from the search engine.

2. The computer-implemented method of claim 1, further comprising:
operatively interfacing the spreadsheet application with a bid management system.

3. The computer-implemented method of claim 2, further comprising:
operatively interfacing the bid management system with the search engine.

4. The computer-implemented method of claim 2, further comprising at least one of:
enabling the user to import at least a portion of the collection of keywords from the bid management system to the spreadsheet application; and
enabling the user to export at least a portion of the collection of keywords from the spreadsheet application to the bid management system.

5. The computer-implemented method of claim 2, further comprising:
enabling the user to manage at least a portion of the collection of keywords via at least one of the bid management system and the spreadsheet application.

6. The computer-implemented method of claim 2, further comprising:
enabling a user to update at least one of a portion and all of the collection of keywords after importing data from the bid management system.

7. The computer-implemented method of claim 2, wherein the spreadsheet application operatively interfaces with the bid management system via a plug-in module.

8. The computer-implemented method of claim 1, wherein at least one of the automatic upload and the automatic download occurs in response to a single input command.

9. A system for handling keywords for Internet advertising, comprising:
a spreadsheet application arranged to operate on a file having a collection of keywords;
a bid management system operatively connected to a search engine and arranged to purchase keywords based on the collection of keywords; and
a plug-in module arranged to at least one of automatically export at least a portion of the collection of keywords from the spreadsheet application to the bid management system and import at least a portion of the collection of keywords to the spreadsheet application from the bid management system.

10. The system of claim 9, further comprising:
a web analytics tool operatively connected to the bid management system and arranged to collect statistics of use of the collection of keywords.

11. The system of claim 9, wherein the plug-in module comprises a file transfer account accessible to a user for one of sending and retrieving keywords.

12. The system of claim 9, wherein the bid management system is further arranged to enable a user to manage the collection of keywords.

13. A computer-readable medium having instructions stored therein and that are executable by a processor, the instructions comprising instructions to:
operatively interface a spreadsheet application with a search engine, wherein the spreadsheet application is arranged to operate on a file having a collection of keywords for Internet advertising; and
enable a user to automatically at least one of upload at least a portion of the collection of keywords to the search engine and download at least a portion of the collection of keywords from the search engine.

14. The computer-readable medium of claim 13, further comprising instructions to:
operatively interface the spreadsheet application with a bid management system.

15. The computer-readable medium of claim 14, further comprising instructions to:
operatively interface the bid management system with the search engine.

16. The computer-readable medium of claim 14, further comprising instructions to at least one of:
enable the user to import at least a portion of the collection of keywords from the bid management system to the spreadsheet application; and
enable the user to export at least a portion of the collection of keywords from the spreadsheet application to the bid management system.

17. The computer-readable medium of claim 14, further comprising instructions to:
enable the user to manage at least a portion of the collection of keywords via the bid management system.

18. The computer-readable medium of claim 14, further comprising instructions to:
enable a user to update at least one of a portion and all of the collection of keywords after importing data from the bid management system.

19. The computer-readable medium of claim 14, wherein the spreadsheet application operatively interfaces with the bid management system via a plug-in module.

20. The computer-readable medium of claim 13, wherein at least one of the automatic upload and the automatic download occurs in response to a single input command.
